(19) United States
(12) Patent Application Publication
(10) Pub. No.: US 2014/0146060 A1
(43) Pub. Date: May 29, 2014

(54) POWER MANAGEMENT METHOD FOR GRAPHIC PROCESSING UNIT AND SYSTEM THEREOF

(71) Applicant: POSTECH ACADEMY - INDUSTRY FOUNDATION, Gyeongbuk (KR)

(72) Inventors: Ki Seok Chung, Gyeongsangbuk-do (KR); Dae Cheol You, Gyeonggi-do (KR)

(73) Assignee: POSTECH ACADEMY - INDUSTRY FOUNDATION, Gyeongbuk (KR)

(21) Appl. No.: 14/039,894

(22) Filed: Sep. 27, 2013

(30) Foreign Application Priority Data
Nov. 27, 2012 (KR) 10-2012-0135007

(51) Int. Cl. G06F 1/32

(52) U.S. Cl. CPC G06F 1/3296
USPC 345/520

(57) ABSTRACT

Disclosed is a power management system that performs power management of a graphic processing unit (GPU). The power management system includes a dynamic voltage and frequency scaling (DVFS) driver configured to include an interface that calls a device driver of the GPU or is called by the device driver, and control an operating voltage and/or an operating frequency of the GPU, and a DVFS governor interface module configured to provide an interface for the DVFS driver to a power management policy module of an operating system (OS). Therefore, in the power management system according to the present invention, a power management policy of the OS based on a change in a workload of the GPU may be applied to the GPU, independently of a hardware configuration of the GPU.

### CLAIM FOR PRIORITY

This application claims priority to Korean Patent Application No. 2012-0135007 filed on Nov. 27, 2012 in the Korean Intellectual Property Office (KIPO), the entire contents of which are hereby incorporated by reference.

### BACKGROUND OF INVENTION

1. Technical Field

Example embodiments of the present invention relate in general to power management of a graphic processing unit (GPU) and more specifically to a method of performing power management of a GPU through dynamic voltage and frequency scaling (DVFS) by defining an interface for power management between a power management module of an operating system (OS) and a device driver of the GPU.

### 2. Related Art

In recent years, a graphic processing unit (GPU) has been developed as a streaming multiprocessor constituting a heterogeneous system together with a general-purpose processor, beyond acting as an existing simple graphic accelerator.

An operational unit of the existing GPU that has been separated into a vertex processor and a fragment processor is integrated as a single shader processor, and even an interconnect interface for connecting an internal memory of the GPU and an internal memory of a central processing unit (CPU) that is a general-purpose processor is added. This means that the GPU does not restrict a target application program to a graphic application program any longer, and is designed for general parallel processing.

The GPU that is actually used in a desktop platform supports general-purpose parallel programming frameworks such as CUDA and OpenCL, and this trend is getting spread even to mobile GPUs used in embedded devices.

However, a high performance-GPU has high power consumption, so that a high-level power management control method (for example, dynamic voltage and frequency scaling (DVFS)) has to be applied in order to reduce the power consumption.

In some applications, a GPU in which a DVFS scheme at a hardware level is applied is used, but even in this case, there is a problem that it would be implemented dependent on a specific power management integrated circuit (PMIC).

In addition, a current OS does not provide a power management interface for the GPU as an operational unit. Thus, it is difficult to apply the existing DVFS scheme that has been widely used for processor power management to the GPU.

The GPU is a simple input/output (I/O) unit in terms of the OS, and therefore a power management interface that can be utilized in terms of the GPU is limited to a simple suspend/resume interface which is mainly applied to an I/O device such as a hard disk.

### SUMMARY OF INVENTION

Accordingly, example embodiments of the present invention are provided to substantially obviate one or more problems due to limitations and disadvantages of the related art.

Example embodiments of the present invention provide a power management system of a graphic processing unit (GPU) which may perform a dynamic voltage and frequency scaling (DVFS) power management policy of an operating system (OS) with respect to the GPU while being independent of implementation of the GPU.

Example embodiments of the present invention also provide a power management method which may perform DVFS power management of the GPU using the above-described power management system of the GPU.

In some example embodiments, a power management system that performs power management of a graphic processing unit (GPU) includes: a dynamic voltage and frequency scaling (DVFS) driver configured to include an interface that calls a device driver of the GPU or is called by the device driver, and control an operating voltage and/or an operating frequency of the GPU; and a DVFS governor interface module configured to provide an interface for the DVFS driver to a power management policy module of an operating system (OS).

The GPU may have at least one domain, and the domain may be a set of at least one processor core sharing the same operating frequency.

The interface included in the DVFS driver may include a function of providing information about the domain.

The information about the domain may include information about the number of domains included in the GPU and information about operating frequencies and/or operating voltages supported by each domain.

The interface included in the DVFS driver may include a function of returning an average time during which the processor cores included in the domain have been in an active state.

The interface included in the DVFS driver may include a function of designating the operating voltage and/or the operating frequency for each domain.

The interface included in the DVFS governor interface module may provide a function of registering the power management policy module of the OS for each domain of the GPU.

The interface included in the DVFS governor interface module may include a function of the power management policy module of the OS designating the operating voltage and/or the operating frequency for each domain of the GPU.

The function of designating the operating voltage and/or operating frequency for each domain of the GPU may select values closest to the voltage and/or frequency values designated by the power management policy module of the OS from the voltage and/or frequency values supported for each domain.

The interface included in the DVFS governor interface module may include a function of returning an average time during which the processor cores included in the domain have been in an active state.

In other example embodiments, a power management method that performs power management of a GPU includes: collecting, by a power management policy module of an OS, information related to the GPU through a DVFS driver for controlling a device driver of the GPU and a DVFS governor interface module for controlling the DVFS driver; and controlling, by the power management policy module of the OS, the device driver of the GPU through the governor interface module and the DVFS driver in accordance with power management policy decision based on the collected information to scale operating voltages and/or operating frequencies of processor cores.

The GPU may have at least one domain, and the domain may be a set of at least one processor core sharing the same operating frequency. The information related to the GPU may include information about the number of domains included in the GPU and information about operating frequencies and/or operating voltages supported by each domain.

The information related to the GPU may include an average time during which the processor cores included in the domain have been in an active state.

### BRIEF DESCRIPTION OF DRAWINGS

Example embodiments of the present invention will become more apparent by describing in detail example embodiments of the present invention with reference to the accompanying drawings, in which:

FIG. 1 is a graph illustrating an example of a change in a workload of a graphic processing unit (GPU);

FIG. 2 is a block diagram illustrating a configuration of a power management system of a GPU according to an embodiment of the present invention; and

FIG. 3 is a flowchart illustrating a power management method using a power management system according to an embodiment of the present invention.

### DETAILED DESCRIPTION

Example embodiments of the present invention are disclosed herein. However, specific structural and functional details disclosed herein are merely representative for purposes of describing example embodiments of the present invention, and thus example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings.

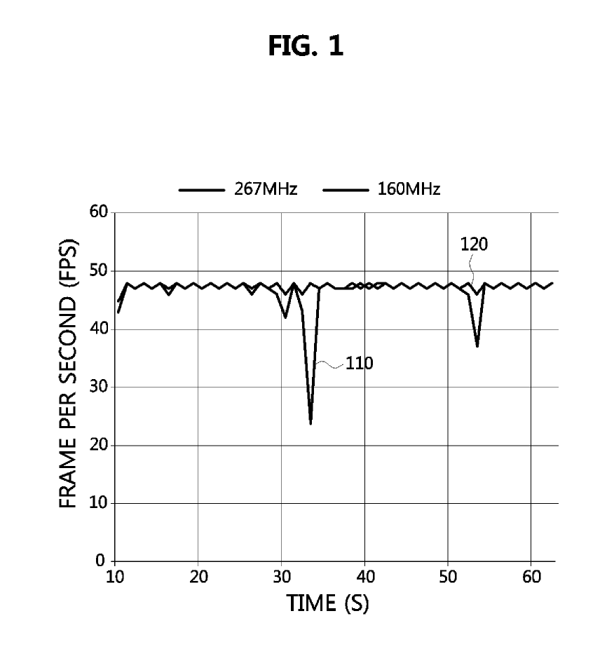

FIG. 1 is a graph illustrating an example of a change in a workload of a graphic processing unit (GPU).

In FIG. 1, when performing Quake III game that is a representative first person shooting (FPS) game, changes in frame per second (FPS) over time in applications using an embedded GPU are shown with respect to two operating frequencies.

In a platform adopted in the above result, an ARM cortex A-9 dual core processor is adopted as a central processing unit (CPU), and Mali-400MP is adopted as a graphic processing unit (GPU). A clock management unit of the platform provides a clock frequency (160 MHz and 267 MHz) scaling scheme with two steps.

An x-axis of FIG. 1 indicates the passage of time expressed in units of seconds, and a y-axis indicates FPS. A solid line 110 of FIG. 1 represents a change in FPS when an operating frequency is 160 MHz, and a dotted line 120 thereof represents a change in FPS when an operating frequency is 267 MHz.

Referring to FIG. 1, it can be experimentally seen that even when an operating frequency of GPU is set as 160 MHz, almost the same FPS as the case in which the operating frequency is set as 267 MHz can be achieved. However, in a case in which the operating frequency is set as 160 MHz compared to a case in which the operating frequency is set as 267 MHz in a specific section, severe performance degradation is observed. This means that GPU applications have significant changes in their workloads, and a GPU is not required to be always operated at a high operating frequency except for a certain period of time requiring high processing power.

A power management system according to an embodiment of the present invention aims to provide a framework that enables a power management policy of an operating system (OS) in response to the above-described change in the workload to be applied to a GPU.

Power management system and power management method according to the present invention

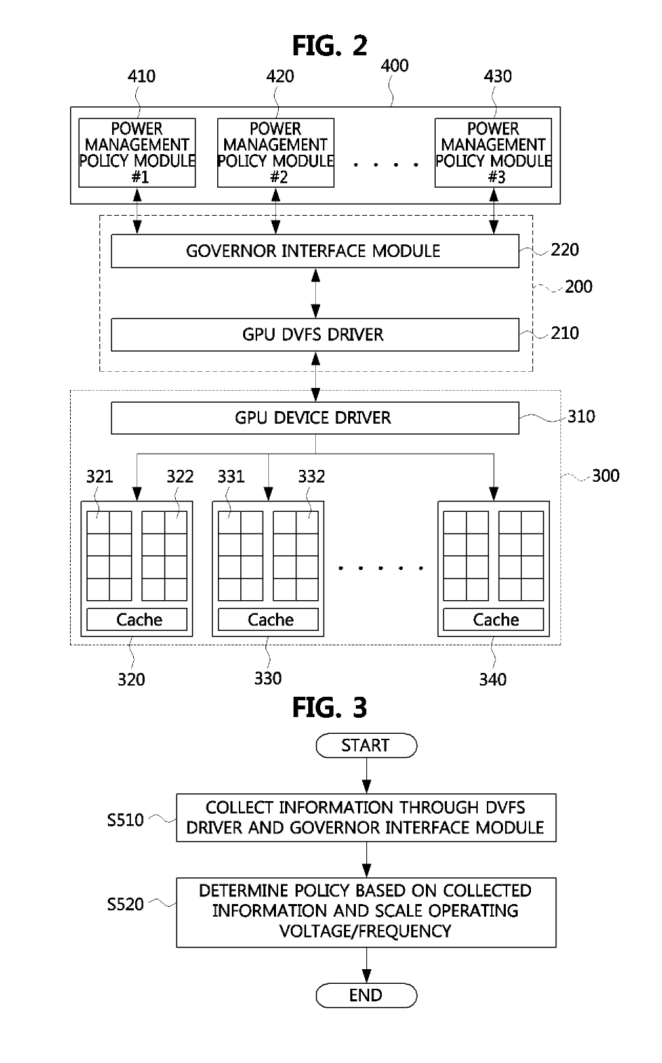

FIG. 2 is a block diagram illustrating a configuration of a power management system of a GPU according to an embodiment of the present invention.

In FIG. 2, a power management system 200 according to an embodiment of the present invention, a GPU 300 to be a target of power management performed by the power management system 200, and power management policy modules 400 of an OS for controlling the power management system are shown.

Referring to FIG. 2, the power management system according to an embodiment of the present invention may include a dynamic voltage and frequency scaling (DVFS) driver 210 and a governor interface module 220.

In this instance, the GPU 300 on which power control is performed by the power management system 200 includes a plurality of processor cores 321, 322, 331, 332, . . . , the processor cores of the GPU sharing the same operating frequency are bound, and the bound processor cores are divided into domains (for example, 320, 330, 340, . . . ).

In addition, the power management system according to an embodiment of the present invention may be operated in conjunction with power management policy modules 410, 420, 430, . . . , and a device driver 310 of the GPU.

The device driver 310 provided by a GPU manufacturer (vendor) performs power management through DVFS in conjunction with components of the power management system defined in the present invention. Accordingly, the device drivers are operated in such a manner as to be called by the DVFS driver which will be described later or to call the DVFS driver.

A power management policy module attached to the OS is a component that collects a variety of information collected from the device driver of the GPU through the DVFS driver and makes a decision related to the DVFS with respect to the GPU. The policy of the power management policy module may be established in unique methods by developers of the OS or the power management policy module. In addition, there may be a plurality of the power management policy modules, and in this case, each of the power management policy modules may be matched and operated for each domain of the GPU.

First, the DVFS driver 210 according to the present invention includes an interface that calls the device driver of the GPU or is called by the device driver, controls the device driver, and controls an operating voltage and/or an operating frequency of the GPU.

An interface of the DVFS driver may be constituted of a function that calls the device driver of the GPU or a callback function that is registered in the device driver to be called.

For example, an interface for setting the operating voltage or the operating frequency with respect to the GPU may be constituted of a function for calling the device driver. On the other hand, an interface for collecting information from the GPU may be implemented as a callback function called by the device driver, and may be configured so as to be called by the device driver whenever a predetermined event occurs.

Obviously, the interface for collecting information from the GPU may be implemented as the function for calling the device driver, and in this case, the DVFS driver has to call periodically or non-periodically the device driver to collect information.

An interface that has to be provided by the DVFS driver may be configured as follows.

First, the DVFS driver has to include a function for providing operating frequency domain information as an interface. The corresponding function registers a table including the number of frequency domains existing in the GPU and operating frequencies supported for each frequency domain. The DVFS driver 210 may collect the above-described information from the device driver of the GPU through control of the governor interface module 220 which will be described later, and transmit the collected information to the power management policy module of the OS.

Second, the DVFS driver 210 has to include a function for returning an average time during which processor cores included in a corresponding domain for each frequency domain are in an active state, as an interface. In this instance, the DVFS driver 210 may be configured so as to return the average time in the form of an accumulated value. For this, the device driver of the GPU has to record a time when a task is allocated to a processor core and a time when the task is completed in the allocated core and separated.

Third, the DVFS driver 210 has to include a function for setting a required operating frequency for each frequency domain as an interface.

Through this, the DVFS driver 210 may set operating frequencies of the processor cores of the GPU as operating frequency values indicated by the power management policy module of the OS through control of the governor interface module which will be described later.

In addition, the governor interface module 220 according to the present invention is a component that provides an interface with respect to the DVFS driver 210 as an environment in which a DVFS scheme can be applied to a power management policy module 400 of the OS.

An interface which has to be provided to the power management policy module of the OS by the governor interface module may be configured as follows.

First, the governor interface module 220 has to provide a function for registering the power management policy module for each frequency domain of the GPU.

Second, the governor interface module 220 has to provide a function that converts the operating frequency requested from the power management policy module into the closest frequency among operating frequency table elements of a frequency domain to be set, and transmits the converted frequency to the driver interface. Here, the closet frequency is registered through a DVFS driver interface.

Third, the governor interface module 220 has to provide a function that converts, into the form of an accumulated value, an average time during which the processor cores included in each frequency domain are in an active state, through the DVFS driver interface.

Based on the above-described framework, power management design that performs DVFS in units of operating frequency domains in accordance with a utilization rate of the processor cores of the GPU may be possible.

FIG. 3 is a flowchart illustrating a power management method using a power management system according to an embodiment of the present invention.

Referring to FIG. 3, a power management method according to an embodiment of the present invention which performs power management of a GPU may include step S510 in which a power management policy module of an OS collects information, and step S520 in which the power management policy module performs a policy based on the collected information.

As described through FIG. 2, the GPU to be a target of power management may have at least one domain, and each domain may be a set of at least one processor core sharing the same operating frequency.

First, in step S510, the power management policy module of the OS collects information related to the GPU through a DVFS driver for controlling a device driver of the GPU and a governor interface module for controlling the DVFS driver.

As a method in which the power management policy module of the OS collects the information related to the GPU, a method of collecting the information by calling the device driver in accordance with a given period of time or a method of providing the information by calling a callback function of the device driver whenever a predetermined event occurs may be given.

The information collected in step S510 may include the number of domains of the GPU, information about operating frequencies and/or operating voltages supported by each domain, and an average time during which the processor cores included in the domain are in an active state.

Next, in step S520, the power management policy module of the OS makes a decision of the power management policy based on the collected information, controls the device driver of the GPU through the governor interface module and the DVFS driver in accordance with the made decision, and scales operating voltages and/or operating frequencies of the processor cores.

A part or all of the above-described information may be required when the power management policy module of the OS makes the decision related to power management.

The power management policy module may scale the operating voltages and/or operating frequencies of the processor cores by controlling the device driver of the GPU through the governor interface module and the DVFS driver.

Experimental Result

The power management system according to an embodiment of the present invention may perform power management of the GPU in such a manner as to increase the operating voltage/frequency when a utilization rate of the GPU is greater than or equal to a predetermined threshold value in accordance with the power management policy of the power management policy module of the OS.

In order to verify the utility of the power management system according to an embodiment of the present invention, in an environment of using the above-described Mali-400MP GPU, benchmarking is performed using a Quake III demo and mobile benchmarking applications (AnTuTu 3D, GLBenchmark Egypt, and GLBenchmark Pro). In the present experimental result, an application that implements a function of measuring GPU performance through OpenGL API has been developed and performed.

In the following Table 1, benchmarking scores (frame counts) with respect to three cases such as a case of applying the power management system according to the present invention, a case of applying a fixed frequency of 267 MHz, and a case of applying a fixed frequency of 160 MHz are summarized.\

TABLE 1

| | | GLBenchmark | GLBenchmark | Quake |
|---|---|---|---|---|
| | | Egypt | Pro | III |
| Application of | 976 | 4085 | 2274 | 2921 |
| DVFS system of | | | | |
| the present | | | | |
| invention | | | | |
| Application of | 983 | 4334 | 2332 | 2927 |
| fixed frequency | | | | |
| of 267 MHz | | | | |
| Application of | 901 | 3194 | 2061 | 2912 |
| fixed frequency | | | | |
| of 160 MHz | | | | |

In addition, in the following Table 2, dynamic power-delay product (PDP) values which are calculated in order to estimate electricity and performance efficiency of the case of applying the power management system according to the present invention are summarized.

TABLE 2

| | | GLBenchmark | GLBenchmark | Quake |
|---|---|---|---|---|
| | AnTuTu 3D | Egypt | Pro | III |
| Application of | 21% | 13% | 11% | 39% |
| DVFS system | | | | |

Based on comparison results of Table 1 and Table 2, when the benchmarking applications adopt the power management system according to the present invention, performance degradation by about 3% (compared to the case of applying the fixed frequency of 267 MHz) is observed, but PDP is reduced by about 15% ((21+13+11)/3). In addition, in case of Quake III, performance degradation by about 1% is observed, but PDP is reduced by about 39%.

In the following Table 3, operating frequencies of the GPU during execution of the benchmarking applications and the Quake III demo are statistically collected.

Referring to the following Table 3, it can be seen that the power management policy module of the OS more aggressively selects a low operating frequency (160 MHz) during execution of the Quake III demo compared to the benchmarking applications.

TABLE 3

| | | GLBenchmark | GLBenchmark | Quake |
|---|---|---|---|---|
| | AnTuTu 3D | Egypt | Pro | III |
| 267 MHz | 60.56% | 75.08% | 80.08% | 23.5% |
| frequency | | | | |
| selection time | | | | |
| 160 MHz | 39.44% | 24.92% | 19.92% | 76.5% |
| frequency | | | | |
| selection time | | | | |

Through the above experimental results, it can be seen that the power management system according to the present invention obtains an effect of a large power reduction (PDP reduction by about 40%) compared to a small performance reduction while abstracting the device driver of the GPU with respect to the power management module of the OS.

As described above, when using the power management system and method of the GPU according to the present invention, DVFS power management may be performed at the level of the OS, independently of a hardware configuration of the GPU.

Since the workload of the GPU exhibits strong time-varying characteristics, when using the power management system according to the present invention, the power management policy of the OS that is optimized for changes in the workload of the GPU may be applied even to the GPU, and therefore heat generation and power consumption may be minimized especially in a mobile environment having a limited battery capacity.

While the example embodiments of the present invention and their advantages have been described in detail, it should be understood that various changes, substitutions, and alterations may be made herein without departing from the scope of the invention.

What is claimed is:

1. A power management system that performs power management of a graphic processing unit (GPU), comprising:
a dynamic voltage and frequency scaling (DVFS) driver configured to include an interface that calls a device driver of the GPU or is called by the device driver, and control an operating voltage and/or an operating frequency of the GPU; and
a DVFS governor interface module configured to provide an interface for the DVFS driver to a power management policy module of an operating system (OS).

2. The power management system of claim 1, wherein the GPU has at least one domain, and the domain is a set of at least one processor core sharing the same operating frequency.

3. The power management system of claim 2, wherein the interface included in the DVFS driver includes a function of providing information about the domain.

4. The power management system of claim 3, wherein the information about the domain includes information about the number of domains included in the GPU and information about operating frequencies and/or operating voltages supported by each domain.

5. The power management system of claim 2, wherein the interface included in the DVFS driver includes a function of returning an average time during which the processor cores included in the domain have been in an active state.

6. The power management system of claim 2, wherein the interface included in the DVFS driver includes a function of designating the operating voltage and/or the operating frequency for each domain.

7. The power management system of claim 2, wherein the interface included in the DVFS governor interface module provides a function of registering the power management policy module of the OS for each domain of the GPU.

8. The power management system of claim 2, wherein the interface included in the DVFS governor interface module includes a function of the power management policy module of the OS designating the operating voltage and/or the operating frequency for each domain of the GPU.

9. The power management system of claim 8, wherein the function of designating the operating voltage and/or operating frequency for each domain of the GPU selects values closest to the voltage and/or frequency values designated by the power management policy module of the OS from the voltage and/or frequency values supported for each domain.

10. The power management system of claim 2, wherein the interface included in the DVFS governor interface module includes a function of returning an average time during which the processor cores included in the domain have been in an active state.

11. A power management method that performs power management of a GPU, comprising:
collecting, by a power management policy module of an OS, information related to the GPU through a DVFS driver for controlling a device driver of the GPU and a DVFS governor interface module for controlling the DVFS driver; and
controlling, by the power management policy module of the OS, the device driver of the GPU through the governor interface module and the DVFS driver in accordance with power management policy decision based on the collected information to scale operating voltages and/or operating frequencies of processor cores.

12. The power management method of claim 11, wherein the GPU has at least one domain, and the domain is a set of at least one processor core sharing the same operating frequency.

13. The power management method of claim 12, wherein the information related to the GPU includes information about the number of domains included in the GPU and information about operating frequencies and/or operating voltages supported by each domain.

14. The power management method of claim 12, wherein the information related to the GPU includes an average time during which the processor cores included in the domain have been in an active state.
